(19) United States
(12) Patent Application Publication
(10) Pub. No.: US 2026/0307525 A1
(43) Pub. Date: Oct. 8, 2026

(54) CHARGING SYSTEM

(71) Applicant: TOYOTA JIDOSHA KABUSHIKI KAISHA, Toyota-shi (JP)

(72) Inventor: Shun SATO, Toyota-shi (JP)

(73) Assignee: TOYOTA JIDOSHA KABUSHIKI KAISHA, Toyota-shi (JP)

(21) Appl. No.: 19/558,987

(22) Filed: Mar. 6, 2026

(30) Foreign Application Priority Data
Mar. 13, 2025 (JP) 2025-040125

(51) Int. Cl. B60L 53/66; B60L 53/62; B60L 53/68; B60L 58/12

(52) U.S. Cl. CPC B60L 53/665; B60L 53/62; B60L 53/68; B60L 58/12; B60L 2250/16

(57) ABSTRACT

A charging system includes a management server that generates a charging plan for charging a battery of a vehicle, a power supply facility that outputs, to the vehicle, a charging command for charging the battery based on the charging plan, and an information processor. The information processor is configured to transmit a notification regarding the setting of a charging limit to a mobile terminal associated with the vehicle on condition that a result of comparison between the charging plan and a charging record of the battery shows a deviation greater than or equal to a specified deviation determined in advance.

### CROSS-REFERENCE TO RELATED APPLICATIONS

This application is based upon and claims the benefit of priority from Japanese Patent Application No. 2025-040125, filed on Mar. 13, 2025, the entire contents of which are incorporated herein by reference.

### BACKGROUND

### 1. Field

The present disclosure relates to a charging system.

### 2. Description of Related Art

JP2023-165164A discloses a charging system. The charging system includes a management server and a power supply facility capable of communicating with the server. The management server generates a charging plan for charging the battery of the vehicle. The power supply facility outputs a charging command to the vehicle in accordance with the charging plan.

In the charging system as described in the above publication, the power supply facility may be configured to enable setting a charging limit that limits charging to the battery is applied. In a state where the charging limit is set, the power supply facility applies the charging limit to the charging plan and then outputs the charging command to the vehicle.

The user of the vehicle may leave the setting of the charging limit on the power supply facility. In this case, the user of the vehicle may not be aware that the battery of the vehicle is not charged according to the charging plan due to the charging limit on the power supply facility.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A charging system according to an aspect includes a management server configured to generate a charging plan for charging a battery of a vehicle equipped with the battery and a power supply facility configured to output, to the vehicle, a charging command for charging the battery based on the charging plan. The power supply facility is configured to enable setting whether a charging limit that limits charging to the battery is applied. The power supply facility is configured to output the charging command without applying the charging limit in accordance with the charging plan when the charging limit is not set and output the charging command with the charging limit applied to the charging plan when the charging limit is set. The charging system further includes an information processor configured to transmit a notification regarding the setting of the charging limit to a mobile terminal associated with the vehicle on condition that a result of comparison between the charging plan and a charging record for charging performed to the battery shows a deviation greater than or equal to a specified deviation determined in advance.

Other features and aspects will be apparent from the following detailed description, the drawings, and the claims.

### BRIEF DESCRIPTION OF THE DRAWINGS

FIG. 1 is a schematic diagram illustrating a charging system according to an embodiment.

FIG. 2 is a flowchart showing a series of processes performed by the power supply facility of the embodiment.

FIG. 3 is a flowchart illustrating a series of processes performed by the management server according to the embodiment.

FIG. 4 is a timing diagram at the time when charging of the embodiment is performed, in which section (a) shows changes in requested power indicated by the charging plan, section (b) shows whether charging is applied according to the charging limit on a power supply facility, and section (c) shows changes in charging power indicated by the charging record.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

Hereinafter, an embodiment of a charging system will be described with reference to the drawings.

### Outline of Charging System

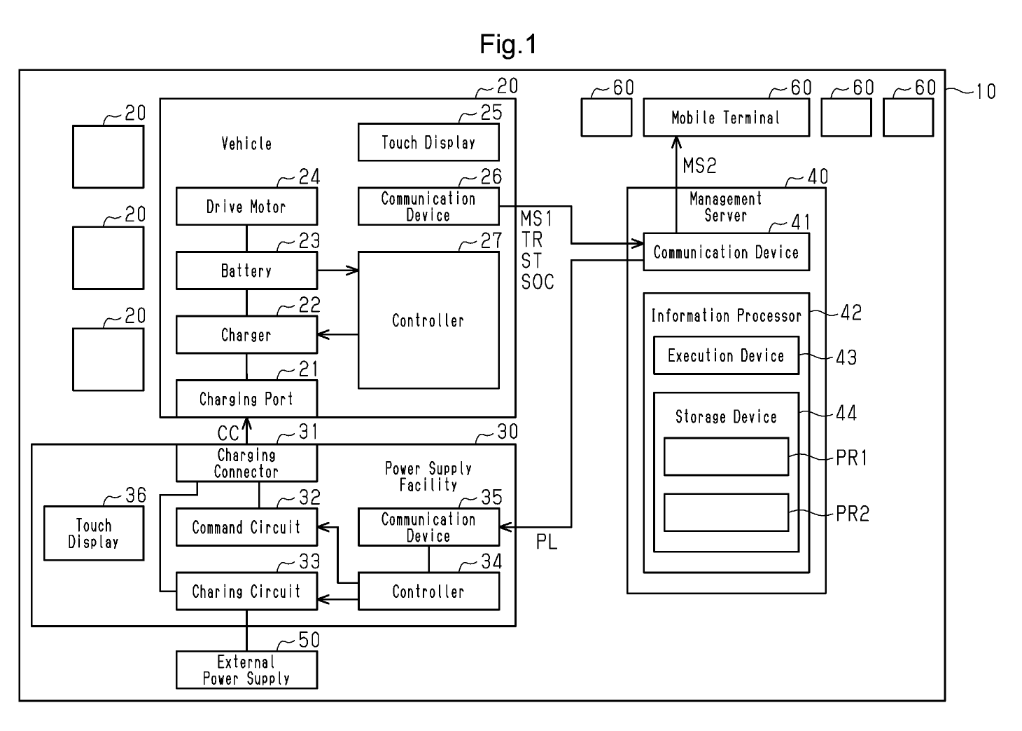

As shown in FIG. 1, a charging system 10 includes a plurality of vehicles 20, a power supply facility 30, a management server 40, an external power supply 50, and a plurality of mobile terminals 60. The charging system 10 manages charging of each vehicle 20 performed by the power supply facility 30.

Each vehicle 20 includes a charging port 21, a charger 22, a battery 23, and a drive motor 24. The vehicle 20 is a battery electric vehicle. Each power supply facility 30 includes a charging connector 31 that is connectable to the corresponding charging port 21. Connecting the charging connector 31 to the charging port 21 allows the power supply facility 30 to charge the battery 23.

The drive motor 24 is a drive source for the vehicle 20. The drive motor 24 drives the vehicle 20 using electrical energy stored in the battery 23. The battery 23 stores electrical energy for operating the drive motor 24.

The charger 22 includes a relay that switches connection and disconnection of an electric power path between the charging port 21 and the battery 23, and a power conversion circuit. The battery 23 is charged by controlling the charger 22.

The vehicle 20 includes a touch display 25, a communication device 26, and a controller 27.

The touch display 25 displays an image such as map information. The touch display 25 receives an operation signal upon receiving a touch operation performed by the user. In the present embodiment, the touch display 25 displays an image for selecting charging in a planned charging mode. The planned charging mode is a charging mode in which charging to the battery 23 is started by a charging command CC from the power supply facility 30 based on a charging plan PL generated by the management server 40. The charging plan PL is time-series data representing requested power that requires charging per unit time in a specified time.

The touch display 25 displays an image for setting a target value of the charging plan PL such that a touch operation for inputting information necessary for the management server 40 to generate the charging plan PL can be received. Upon the touch operation, the touch display 25 receives the next scheduled usage time ST and the target state of charge TR as the target value of the charging plan PL. When the touch display 25 receives a next scheduled usage time ST and the target state of charge TR, the touch display 25 outputs the next scheduled usage time ST and the target state of charge TR to the controller 27.

The communication device 26 can communicate with the management server 40 via a wireless communication line. When the communication device 26 receives an operation signal indicating that the planned charging mode has been set from controller 27, the communication device 26 transmits a setting notification MS1 to the management server 40. When the communication device 26 receives the next scheduled usage time ST and the target state of charge TR from the controller 27, the communication device 26 transmits the next scheduled usage time ST and the target state of charge TR to the management server 40.

When the charging according to the charging plan PL ends, the communication device 26 transmits, to the management server 40, the state of charge SOC of the battery 23 obtained at the time when the charging according to the charging plan PL ends. In response to a request from the controller 27, the communication device 26 transmits, to the management server 40, the charging record CR obtained when charging is performed in accordance with the single charging plan PL. The charging record CR is time-series data representing charging power per unit time including a period in which charging according to the charging plan PL is requested.

The controller 27 controls the charger 22 to charge the battery 23. Upon detecting that the charging connector 31 has been connected to the charging port 21, the controller 27 controls the charger 22 to start charging the battery 23. The controller 27 refers to the state of charge SOC of the battery 23 and controls the charger 22 to end the charging to the battery 23. The controller 27 controls the communication device 26 so as to transmit various signals from the communication device 26 to the management server 40.

The management server 40 includes a communication device 41 and an information processor 42. The communication device 41 can communicate with the vehicle 20 and the power supply facility 30 via a wireless communication line. The communication device 41 receives the setting notification MS1 from the vehicles 20. The communication device 41 receives a signal indicating the next scheduled usage time ST and a signal indicating the target state of charge TR from the vehicle 20. The communication device 41 transmits the charging plan PL to the power supply facility 30.

The information processor 42 includes an execution device 43 and a storage device 44. The execution device 43 is a CPU including a processor. The storage device 44 is a memory. The storage device 44 stores a generation program PR1 and a notification program PR2.

The generation program PR1 is a program that is executed by the execution device 43 to generate the charging plan PL for the vehicles 20. The notification program PR2 is a program that is executed by the execution device 43 to transmit a notification MS2 related to setting of a charging limit CL, which will be described later, to the mobile device 60 associated with the vehicle 20.

When the communication device 41 receives the setting notification MS1, the execution device 43 starts execution of the generation program PR1. When the generation program PR1 is executed, the execution device 43 generates the charging plan PL on the basis of the next scheduled usage time TS and the target state of charge TR. Specifically, the execution device 43 calculates a start time TS at which charging is to be started when charging is performed with a specified charge amount per unit time so that the target charge rate TR is reached at the next scheduled usage time ST. Then, the execution device 43 generates the charging plan PL for charging at a specified charging amount per unit time from the start time TS to the next scheduled usage time ST. The execution device 43 may generate the charging plan PL in which the charging amount per unit time varies depending on the time period, for example, on the basis of the power rate that varies depending on the time period. Then, the execution device 43 transmits a signal indicating the generated charging plan PL from the communication device 41 to the power supply facility 30.

The storage device 44 stores information indicating the mobile terminal 60 associated with the vehicle 20. The mobile terminal 60 is, for example, a terminal of a user of the vehicle 20. The mobile device 60 displays the notification MS2 regarding the setting of the charging limit received from the management server 40.

Each power supply facility 30 supplies electric power from the external power supply 50 to the corresponding vehicle 20 to charge the battery 23 of the vehicle 20. The power supply facility 30 is electric vehicle supply equipment (EVSE). The power supply facility 30 includes a charging connector 31, a command circuit 32, a charging circuit 33, a controller 34, a communication device 35, and a touch display 36.

Each charging connector 31 is connectable to the charging port 21 of the corresponding vehicle 20. The charging connector 31 is connected to the command circuit 32 via a cable. The charging connector 31 is connected to the external power supply 50 via the charging circuit 33 by a cable. The external power supply 50 is located outside the vehicle 20. Connecting the charging connector 31 to the charging port 21 allows the power supply facility 30 to supply electric power from the external power supply 50 to the battery 23 via the charging circuit 33.

The command circuit 32 is a circuit for transmitting a charging command CC to the vehicle 20. Charging the charging connector 31 to the charging port 21 allows the command circuit 32 to send a charging command CC to the vehicle 20. The charge command CC includes a command of a charge amount per unit time.

The charging circuit 33 charges the battery 23 from the external power supply 50. Connecting the charging connector 31 to the charging port 21 allows the charging circuit 33 to supply electric power from the external power supply 50 to the battery 23.

The communication device 35 can communicate with the management server 40 via a wireless communication line. The communication device 35 receives information indicating the charging plan PL from the management server 40.

The touch display 36 is configured to enable set whether the charging limit CL is applied by the power supply facility 30. The touch display 36 displays a setting image capable of receiving a setting related to the charging limit CL at the power supply facility 30. The touch display 36 receives whether the charging limit CL is applied by the power supply facility 30.

The charging limit CL is control for limiting charging to the battery 23 in comparison with the requested power. The charging limit CL includes a limit on the time for which the charging command CC is output and a limit on the magnitude of the charging power to be charged by the charging command CC.

The limit on the time for outputting the charge command CC is, for example, to allow the output of the charge command CC at the time when the electricity price is less than a specified price and to prohibit the output of the charge command CC at the time when the electricity price is greater than or equal to the specified price in accordance with the fact that the electricity price varies depending on the time period.

The limit on the magnitude of the charging electric power scheduled to be charged by the charging command CC is, for example, to limit the charging electric power to the charging electric power at which the electricity price is less than the specified price when the charging electric power at which the electricity price is greater than or equal to the specified price is requested in accordance with the fact that the electricity price varies according to the charging electric power.

When the touch display 36 receives an operation indicating that the charging limit CL is set, the touch display 36 outputs a signal indicating that the charging limit CL is set to the controller 34. When the controller 34 acquires the signal indicating that the charging limit CL has been set, the controller 34 updates the flag indicating whether the charging limit CL has been set to a state indicating that the charging limit CL has been set.

When the touch display 36 receives an operation indicating that the charging limit CL is not set, the touch display 36 outputs a signal indicating that the charging limit CL is not set to the controller 34. When the controller 34 acquires the signal indicating that the charging limit CL is not set, the controller 34 updates the flag indicating whether the charging limit CL is set to a state indicating that the charging limit CL is not set.

When receiving the charging plan PL from the management server 40, the controller 34 controls the command circuit 32 to perform charging in the planned charging mode. Specifically, the controller 34 controls the command circuit 32 to output the charging command CC based on the charging plan PL.

When the controller 34 receives the charging plan PL from the management server 40, the controller 34 performs a series of processes for selecting a method of outputting the charging command CC according to the charging plan PL and the presence or absence of the setting of the charging limit CL.

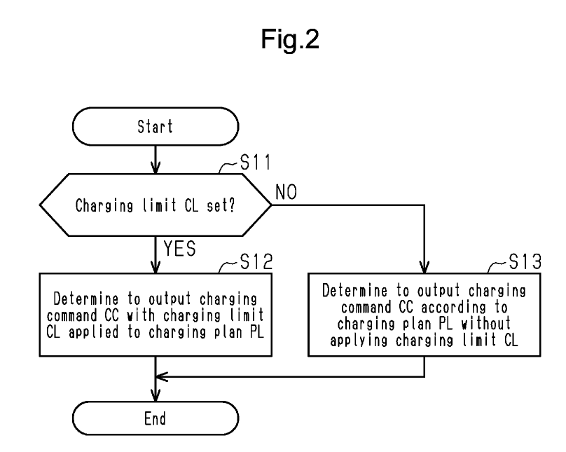

As shown in FIG. 2, when the controller 34 receives the charging plan PL from the management server 40, the controller 34 first performs a process of step S11. In step S11, the controller 34 determines whether the charging limit is set. Specifically, the controller 34 determines whether the charging limit CL is set with reference to the state of the flag indicating whether the charging limit CL is set.

When the charging limit is set (S11: YES), the controller 34 advances the process to step S12. In step S12, the controller 34 determines to output the charging command CC after adding the charging limit CL to the charging plan PL.

After performing the process of step S12, the controller 34 controls the command circuit 32 to output the charging command CC after adding the charging limit CL to the charging plan PL when the battery 23 is charged according to the received charging plan PL. Subsequently, the controller 34 ends the series of processes in the current cycle.

When the charging limit has not been set (S12: NO), the controller 34 advances the process to step S13. In step S13, the controller 34 determines to output the charging command CC without applying the charging limit CL in accordance with the charging plan PL.

After performing the process of step S13, the controller 34 controls the command circuit 32 to output the charging command CC without adding the charging limit CL in accordance with the charging plan PL when the battery 23 is charged in accordance with the received charging plan PL. Subsequently, the controller 34 ends the series of processes in the current cycle.

Series of Processes for Transmitting Notification Related to Charging Limit.

As shown in FIG. 1, when the charging according to the charging plan PL is finished, the execution device 43 starts the execution of the notification program PR2.

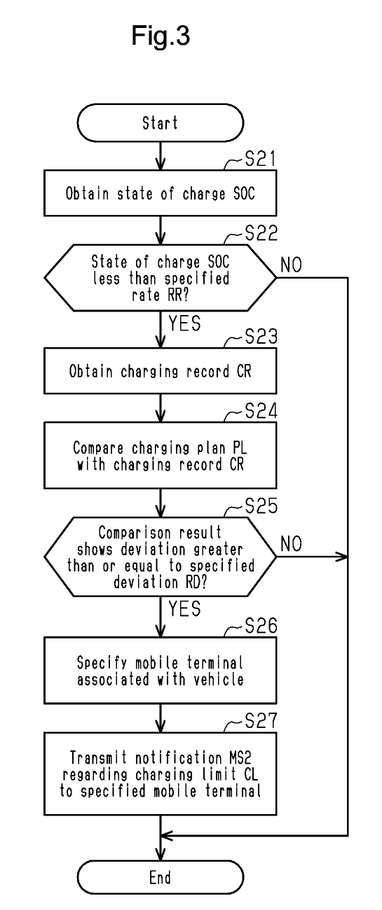

As shown in FIG. 3, when the execution device 43 starts the execution of the notification program PR2, the execution device 43 first performs the process of step S21. In step S21, the execution device 43 acquires the state of charge SOC. Specifically, when the charging according to the charging plan PL ends, the execution device 43 acquires, from the communication device 41, the state of charge SOC at the time when the charging according to the charging plan PL transmitted from the vehicle 20 ends. Then, the execution device 43 advances the process to step S22.

In step S22, the execution device 43 determines whether the state of charge SOC acquired in step S21 is less than a specified rate RR. The specified rate RR is determined in advance by a test or a simulation as a lower limit state of charge SOC for the controller 27 to control the charger 22 so as to limit the charging to the battery 23 with reference to the state of charge SOC of the battery 23.

When the state of charge SOC is greater than or equal to the specified rate RR (S22: NO), the execution device 43 ends the current series of processes. That is, when the state of charge SOC is greater than or equal to the specified rate RR, the execution device 43 does not transmit the notification MS2 regarding the charging limit.

When the state of charge SOC is less than the specified rate RR (S22: YES), the execution device 43 advances the process to step S23. In step S23, the execution device 43 acquires the charging record CR from the vehicles 20. Specifically, the execution device 43 transmits a transmission request for the charging record CR to the vehicle 20. Next, when the vehicle 20 receives the transmission request for the charging record CR, the controller 27 transmits the charging record CR from the communication device 26 to the management server 40. Then, the execution device 43 acquires the charging record CR from the vehicle 20 via the communication device 41. Then, the execution device 43 advances the process to step S24.

In step S24, the execution device 43 compares the charging plan PL with the charging record CR. Specifically, the execution device 43 compares the requested power of the charging plan PL with the charging power of the charging record CR that were obtained at the same time. The execution device 43 calculates, as the comparison result, time-series data representing a comparison parameter obtained by dividing the charging power of the charging record CR at the same time by the requested power of the charging plan PL. Thereafter, the execution device 43 advances the process to step S25.

In step S25, the execution device 43 determines whether there is a deviation greater than or equal to a specified deviation RD determined in advance in the comparison result. The deviation greater than or equal to the specified deviation RD includes a deviation in charging time and a deviation in charging power. The deviation of the charging time indicates that the period during which charging is not performed in the charging record CR is greater than or equal to a specified period determined in advance in the period during which the requested power is requested according to the charging plan PL. The deviation of the charging power indicates that the amount by which the charging power of the charging record CR falls below the requested power according to the charging plan PL is greater than or equal to a specified amount. That is, the specified deviation RD includes the specified period and the specified amount. The specified degree of deviation RD including the specified period and the specified amount is determined in advance through testing or simulation as a value in a case where there is a sufficient deviation.

The execution device 43 refers to the comparison parameter calculated in step S24, and determines that there is a deviation greater than or equal to the specified deviation RD in the comparison result when there is at least one of a deviation in the charging time and a deviation in the charging power in the comparison result. The execution device 43 refers to the comparison parameter calculated in step S24, and determines that there is no deviation greater than or equal to the specified deviation RD in the comparison result when there is no deviation of any of the deviation of the charging time and the deviation of the charging power in the comparison result.

When there is no deviation greater than or equal to the specified deviation RD in the comparison result (S25: NO), the execution device 43 ends the current series of processes. That is, when there is no deviation greater than or equal to the specified deviation RD in the comparison result, the execution device 43 does not transmit the notification MS2 regarding the charging limit CL.

When there is a deviation greater than or equal to the specified deviation RD in the comparison result (S25: YES), the execution device 43 advances the process to step S26. In step S26, the execution device 43 specifies the mobile terminals 60 associated with the vehicles 20 charged according to the charging plan PL. Then, the execution device 43 advances the process to step S27.

In step S27, the execution device 43 transmits a notification MS2 regarding the charging limit CL to the mobile device 60 specified in step S26. The notification MS2 regarding the charging limit CL is a notification indicating that the power supply facility 30 is set to perform the charging limit CL. That is, on the condition that the state of charge SOC is less than the specified rate RR and the comparison result obtained by comparing the charging plan PL and the charging record CR has a deviation greater than or equal to the specified deviation RD, the execution device 43 transmits the notification MS2 related to the charging limit CL to the mobile device 60 associated with the vehicle 20. Then, the execution device 43 ends the series of processes in the present cycle.

### Operation of the Present Embodiment

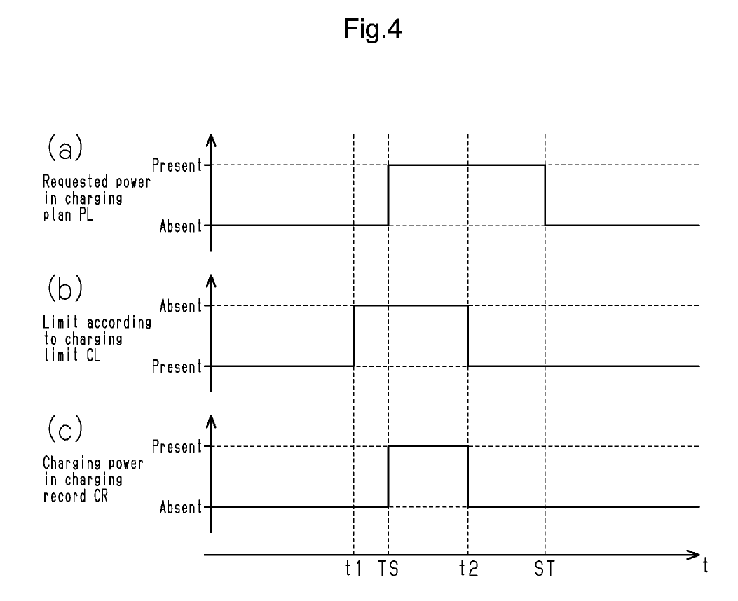

As shown in section (b) of FIG. 4, the operation of the present embodiment will be described by taking, as an example, a case where the power supply facility 30 is set to perform the charging limit CL, which permits the output of the charging command CC only from time t1 to time t2, which is subsequent to time t1.

The charging power by the charging limit CL is limited to zero until time t1. The charging power by the charging limit CL is not limited during the period from time t1 to time t2. The charging power by the charging limit CL is limited to zero from time t2. Therefore, the charging limit CL includes a limit in which the period for outputting the charging command CC is only the period from time t1 to time t2.

As shown in section (a) of FIG. 4, the start time TS of charging plan PL obtained by power supply facility 30 is time t after time t1 and before time t2. The scheduled next usage time ST that is the end time of the charging plan PL acquired by the power supply facility 30 is time t after time t2.

In such a case, when the power supply facility 30 adds the charging limit CL to the charging plan PL and outputs the charging command CC, the power supply facility 30 does not output the charging command CC until the start time TS because there is no electric power requested by the charging plan PL. From the start time TS to time t2, since requested power is specified by the charging plan PL and outputting the charging command CC is permitted by the charging limit CL, the power supply facility 30 outputs the charging command CC. Further, the power supply facility 30 does not output the charging command CC during the period from time t2 to the next scheduled usage time TS, because the power supply facility 30 is prohibited from outputting the charging command CC due to the charging limit CL although the power supply facility 30 has the requested power according to the charging plan PL.

As a result, as shown in the section (c) of FIG. 4, the charging power of the charging record CR in such a case is zero until the start time TS because charging is not performed. In other words, there is no charging power until the start time TS. The charging electric power of the charging record CR matches the requested power between the start time TS and time t2. That is, there is charging power from the start time TS to time t2. The charging electric power of the charging record CR is not charged between time t2 and the next scheduled usage time TS, and thus is zero. In other words, there is no charging power from time t2 to the next scheduled usage time.

As a result, the period from time t2 to the next scheduled usage time ST is a time during which charging is not performed with the charging record CR among times during which charging is requested by the charging plan PL. Then, when the period from time t2 to the next scheduled usage time ST becomes greater than or equal to the specified period included in the specified deviation RD, the information processor 42 transmits a notification MS2 related to the charging limit CL to the mobile device 60 associated with the vehicle 20.

### Advantages of the Present Embodiment

(1) According to the above-described charging system 10, when there is a deviation in the comparison result between the charging plan PL and the charging record CR, the information processor 42 transmits the notification MS2 regarding the setting of the charging limit CL to the mobile device 60 associated with the vehicle 20. Therefore, the charging system 10 can prevent the user of the vehicle 20 from not noticing that the battery 23 of the vehicle 20 is not charged in accordance with the charging plan PL due to the charging limit CL of the power supply facility 30. In other words, according to the charging system 10, the user of the vehicle 20 can notice that the battery 23 of the vehicle 20 is not charged in accordance with the charging plan PL due to the charging limit CL of the power supply facility 30.
(2) When the state of charge SOC is greater than or equal to the specified rate RR, the vehicle 20 may limit charging with reference to the state of charge SOC. In this regard, according to the charging system 10 described above, the information processor 42 does not transmit the notification MS2 regarding the setting of the charging limit CL when the state of charge SOC is greater than or equal to the specified rate RR. Therefore, when charging is limited by the vehicles 20, it is not necessary to transmit the notification MS2 regarding the charging limit CL of the power supply facility 30.
(3) The charging limit CL includes a limit on the time during which the charging command CC is output. The information processor 42 determines that there is a deviation greater than or equal to the specified deviation RD when the time during which charging is not performed in the charging record CR is greater than or equal to a specified period determined in advance in the time during which the requested power is requested by the charging plan PL. Therefore, for example, when the battery 23 is not charged only temporarily, the charging system 10 can suppress the determination that there is a deviation.
(4) The charging limit CL includes a limit of the magnitude of the charging power scheduled to be charged by the charging command CC. The information processor 42 determines that there is a deviation greater than or equal to the specified deviation RD when the amount by which the charging power of the charging record CR falls below the requested power for which charging is requested by the charging plan PL is greater than or equal to a specified amount determined in advance. Therefore, when there is an error such that the charging electric power is slightly deviated from the requested power of the charging plan PL, the charging system 10 can suppress the determination that there is a deviation.
(5) The management server 40 includes the information processor 42. The management server 40 can communicate with the plurality of mobile terminals 60 and the plurality of vehicles 20. Therefore, since the management server 40 includes the information processor 42, the information processor 42 does not need to include a device capable of communicating with the plurality of mobile terminals 60 and the plurality of vehicles 20 separately from the management server 40.

### Modifications

The above embodiment may be modified as follows. The above-described embodiment and the following modifications can be combined as long as the combined modifications remain technically consistent with each other.

The information processor 42 may be configured as circuitry including one or more processors that execute various types of processes according to a computer program (software). The information processor 42 may be circuitry including one or more dedicated hardware circuits such as application specific integrated circuits (ASICs) that execute at least part of various processes or including a combination thereof. The processor includes a CPU and a memory, such as a RAM and a ROM. The memory stores program codes or instructions configured to cause the CPU to execute the processes. The memory, which is a non-transitory computer-readable storage medium, includes any type of media that are accessible by general-purpose computers and dedicated computers. The same applies to the controllers 27 and 34.

The information processor 42 does not have to transmit the notification MS2 regarding the setting of the charging limit CL under a further condition that the state of charge SOC of the battery 23 when comparing the charging plan PL with the charging record CR is less than the specified rate RR.

The charging limit CL does not have to include the limit on the time for outputting the charging command CC. For example, the charging limit CL may be only the limit of the magnitude of the charging electric power by the charging command CC. In this case, the specified deviation RD may be only the specified amount.

The charging limit CL does not have to include the limit of the magnitude of the charging electric power to be charged by the charging command CC. For example, the charging limit CL may be only a limit on the time for outputting the charging command CC. In this case, the specified deviation RD may be only the specified amount.

The information processor 42 does not have to be included in the management server 40, and may be included in the charging system 10 separately from the management server 40. For example, the information processor 42 may be provided in the vehicle 20, or may be provided in the power supply facility 30. In these cases, the management server 40 may include a computer that executes the generation program PR1, and the information processor 42 may execute the notification program PR2.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A charging system, comprising:
a management server configured to generate a charging plan for charging a battery of a vehicle equipped with the battery; and
a power supply facility configured to output, to the vehicle, a charging command for charging the battery based on the charging plan, wherein
the power supply facility is configured to enable setting whether a charging limit that limits charging to the battery is applied,
the power supply facility is configured to output the charging command without applying the charging limit in accordance with the charging plan when the charging limit is not set and output the charging command with the charging limit applied to the charging plan when the charging limit is set, and
the charging system further comprises an information processor configured to transmit a notification regarding the setting of the charging limit to a mobile terminal associated with the vehicle on condition that a result of comparison between the charging plan and a charging record for charging performed to the battery shows a deviation greater than or equal to a specified deviation determined in advance.

2. The charging system according to claim 1, wherein
the information processor is configured to transmit the notification regarding the setting of the charging limit to the mobile terminal under a further condition that a state of charge of the battery during the comparison between the charging plan and the charging record is less than a specified rate determined in advance when transmitting the notification regarding the setting of the charging limit.

3. The charging system according to claim 1, wherein
the charging limit includes a limit on a time for outputting the charging command, and
the information processor is configured to determine that the deviation greater than or equal to the specified deviation has occurred when a period during which charging has not been performed in a scheduled period for charging according to the charging plan is greater than or equal to a specified period determined in advance.

4. The charging system according to claim 1, wherein
the charging limit includes a limit on a magnitude of a charging power scheduled to be supplied according to the charging command, and
the information processor is configured to determine that the deviation greater than or equal to the specified deviation has occurred when an amount by which a charging power of the charging record falls below a requested power requested for charging according to the charging plan is greater than or equal to a specified amount determined in advance.

5. The charging system according to claim 1, wherein
the management server includes the information processor.
